(19) United States
(12) Patent Application Publication
(10) Pub. No.: US 2025/0254656 A1
(43) Pub. Date: Aug. 7, 2025

(54) MANAGING DISCONTINUOUS COVERAGE AND DISCONTINUOUS RECEPTION IN NTN

(71) Applicant: Google LLC, MOUNTAIN VIEW, CA (US)

(72) Inventors: Chih-Hsiang WU, Taoyuan City (TW); Ming-Hung TAO, Taoyuan City (TW)

(21) Appl. No.: 18/855,247

(22) PCT Filed: Apr. 24, 2023
(86) PCT No.: PCT/US2023/019615

§ 371 Date: Oct. 8, 2024

Related U.S. Application Data
(60) Provisional application No. 63/363,574, filed on Apr. 25, 2022.

(51) Int. Cl. H04W 68/02; H04B 7/185; H04B 7/195; H04W 24/08

(52) U.S. Cl. CPC H04W 68/02; H04B 7/18547; H04W 24/08; H04B 7/195

(57) ABSTRACT

A network device performs a method for paging a user equipment (UE). The network device transmits, to the UE, non-terrestrial network (NTN) cell-related assistance information. The cell-related assistance information includes attributes defining one or more NTN cells including a serving cell of the UE projected onto a certain geographical area, and a reference location and a radius of the serving cell. The network device may also transmit, to the UE, a configuration configuring the UE to monitor paging messages during a paging time window (PTW) while the UE operates in a non-connected state.

### FIELD OF THE DISCLOSURE

This disclosure relates generally to methods, devices and articles in wireless communication systems, such as 3GPP communication systems.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The objectives behind developing the fifth generation (5G) technology include providing a unified framework for such types of communication as enhanced mobile broadband (eMBB), ultra-reliable low-latency communications (URLLC), and massive machine type communication (mMTC).

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, an RF transceiver is amounted on a satellite, an unmanned aircraft systems (UAS) also called drone, balloon, plane, or another suitable apparatus. For simplicity, the discussion below refers to all such apparatus as satellites. In addition to satellites, an NTN can include the sat-gateways that connect the Non-Terrestrial Network to a public data network, feeder links between sat-gateways and satellites, service links between satellites, and inter-satellite links (ISL) when satellites form constellations.

A satellite can belong to one of several types based on altitude, orbit, and beam footprint size. The types include Low-Earth Orbit (LEO) satellite, Medium-Earth Orbit (LEO) satellite, Geostationary Earth Orbit (GEO) satellite, UAS platform (including High Altitude Platform Station, HAPS), and High Elliptical Orbit (HEO) satellite. GEO satellites are also known as the Geosynchronous Orbit (GSO) satellites, and LEO/MEO satellites are also known as the non-GSO (NGSO) satellites.

A GSO satellite can communicate with one or several sat-gateways deployed over a satellite targeted coverage area (e.g. a region or even a continent). A non-GSO satellite at different times can communicate with one or several serving sat-gateways. An NTN is designed to ensure service and feeder link continuity between successive serving sat-gateways, with sufficient time duration to proceed with mobility anchoring and hand-over.

A satellite can support a transparent or a regenerative (with on board processing) payload, and typically generates several beams for a given service area bounded by the field of view. The footprints of the beams typically have an elliptic shape and depend on the on-board antenna configuration and the elevation angle. For a transparent payload implementation, a satellite can apply RF filtering and frequency conversion and amplification, and not change the waveform signal. For a regenerative payload implementation, a satellite can apply RF filtering, frequency conversion and amplification, demodulation and decoding, routing, and coding/modulation. This approach is effectively equivalent to implementing most of the functions of a base station, e.g., a gNB.

NB-IoT and eMTC technologies are expected to be particularly suitable for IoT devices operating in remote areas with limited or no terrestrial connectivity. Such IoT devices can be used in a variety of industries including for example transportation (maritime, road, rail, air) and logistics; solar, oil, and gas harvesting; utilities; farming; environmental monitoring; and mining. However, to ensure the required IoT connectivity, deployment of these technologies requires satellite connectivity to provide coverage beyond terrestrial deployments. Satellite NB-IoT or eMTC is defined in a complementary manner to terrestrial deployments.

In these and other applications, a user equipment (UE) can experience time-discontinuous coverage, and have coverage only occasionally. Moreover, because a UE in such applications often has limited power, the UE can wake up only periodically, and operate in the sleep mode with no connectivity between these relatively short periods. When the times when the UE is awake do not align with the times of coverage well, the UE can be unreachable for long periods of time.

### SUMMARY

Generally speaking, the techniques of this disclosure allow a UE to monitor paging more efficiently. The UE and the network use these techniques to align a paging time window (PTW) with periods of satellite coverage, so as to reduce the number of instances where the UE wakes up but cannot receive any downlink signals, thereby using power inefficiently. Further, these techniques improve the chances that the network can page the UE to deliver a notification or data.

One example embodiment of these techniques is a method for monitoring paging from a non-terrestrial network (NTN). The method is implemented in a UE and comprises receiving, by one or more processors from the NTN, a configuration of a PTW during which the UE operating in non-connected state monitors paging messages and after the PTW, enters a sleep period during which the UE operates in a low-power sleep mode; determining, by the one or more processors, that the UE lacks NTN coverage during the PTW; and modifying, by the one or more processors, the PTW to generate a modified PTW in response to the determining.

Another example embodiment of these techniques is a method for monitoring paging from an NTN. The method is implemented in a UE and comprises receiving, from the NTN and when the UE is in a connected state, a first paging time window (PTW) indication specifying a first PTW during which the UE operating in non-connected state monitors paging messages; and receiving, by one or more processors during the PTW, a second PTW indication specifying a second PTW.

Still another example embodiment of these techniques is a UE comprising one or more processors and configured to implement the methods above.

Another example embodiment of these techniques is a method for paging, via an NTN, a UE configured with a PTW during which the UE operating in non-connected state monitors paging messages, and after the PTW, enters a sleep period during which the UE operates in a lower-power sleep mode. The method is implemented in a network device and comprises providing, by one or more processors to the UE, an indication that the UE is to modify the PTW if the UE lacks NTN coverage during the PTW; modifying, by the one or more processors, the PTW to generate a modified PTW; and paging, by the one or more processors, during to the modified PTW.

Yet another example embodiment of these techniques is a method for paging a UE via an NTN, the method implemented in a network device and comprising: transmitting, by one or more processors to the UE when the UE is in a connected state, a first PTW indication specifying a first PTW during which the UE operating in non-connected state monitors paging messages; and transmitting, by one or more processors to the UE during the PTW, a second PTW indication specifying a second PTW.

Still another embodiment of these techniques is a method for paging, via an NTN, a UE, the method comprising: determining, by one or processors, a periodicity of coverage periods during which a certain satellite provides coverage to the UE, the coverage periods separated by intervals of time during which the satellite does not provide coverage to the UE; generating, by the one or more processors, a configuration of a paging cycle including (i) a PTW during which the UE operating in non-connected state monitors paging messages, and (ii) a sleep period during which the UE operates in a sleep mode, including selection a duration of the paging cycle based on the periodicity of the coverage periods; and transmitting, by the one or more processors to the UE, the configuration.

Another example embodiment of these techniques is a network device comprising one or more processors and configured to implement the methods above.

### BRIEF DESCRIPTION OF THE DRAWINGS

FIG. 1A is a block diagram of an example wireless communication system in which a user device and a base station of this disclosure can implement the paging techniques of this disclosure;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A is a block diagram of an example NTN node with transparent payload implementation;

FIG. 3B is a block diagram of an example NTN node with transparent payload implementation, in which a base station connects to multiple satellites via the same sat-gateway;

FIG. 4A illustrates an exemplary user plane protocol stack for use with the architecture of FIG. 3A;

FIG. 4B illustrates an exemplary control plane protocol stack for use with the architecture of FIG. 3A;

FIG. 5 illustrates example configuration according to which a UE implements extended Discontinuous Reception (eDRX);

FIG. 6 illustrates an example scenario in which a UE has satellite coverage during certain time periods separated by intervals of non-coverage;

FIG. 7 illustrates an example scenario in which a user equipment is configured with eDRX and is experiencing discontinuous coverage in an NTN environment;

FIG. 8 is a flow diagram of an example method for estimating the periods of discontinuous coverage in an NTN, which can be implemented by a user equipment of this disclosure;

FIG. 9 illustrates how a UE can use example assistance information including attributes of a cell;

FIG. 10 illustrates how a UE can use example assistance information including attributes of a satellite;

FIG. 11 illustrates an example scenario in which the UE and the network adjust the PTW timing so as to align a PTW with a period of satellite coverage;

FIG. 12 is a messaging diagram of an example scenario in which the UE and the network exchange messages for aligning the PTW timing with a period of satellite coverage;

FIG. 13 is a flow diagram of an example method for determining whether to shift the PTW, and by how much, which can be implemented by a UE of this disclosure;

FIG. 14 illustrates an example scenario in which the UE and the network extend the duration of a PTW to at least overlap a period of satellite coverage;

FIG. 15 is a messaging diagram of an example scenario in which the UE and the network exchange messages for extending the PTW length;

FIG. 16 is a flow diagram of an example method for determining whether to extend the PTW, which can be implemented by a user equipment of this disclosure;

FIG. 17 illustrates an example scenario in which the network dynamically configures the UE with the next PTW;

FIG. 18 illustrates an example messaging diagram of an example scenario in which the UE and the network exchange messages for dynamically configuring upcoming PTWs;

FIG. 19 is a flow diagram of an example method for determining when to start a dynamically configured PTW, which can be implemented in a user equipment of this disclosure;

FIG. 20 illustrates an example scenario in which the UE and the network implement a mechanism for aligning eDRX cycled with the periodicity of a certain satellite covering a certain area;

FIG. 21 is a flow diagram of an example method for paging a UE via an NTN using modifications of an initial PTW configuration, which can be implemented in a base station and/or an MME of this disclosure;

FIG. 22 is a flow diagram of an example method for paging a UE via an NTN using dynamic “next PTW” indications, which can be implemented in a base station and/or an MME of this disclosure; and

FIG. 23 is a flow diagram of an example method for paging a UE via an NTN using alignment of a PTW with periodicity of satellite coverage, which can be implemented in a base station and/or an MME of this disclosure.

### DETAILED DESCRIPTION OF THE DRAWINGS

As discussed in more detail below, a user equipment (UE) and/or a network node of a radio access network (RAN) can use the techniques of this disclosure for managing early data communication and transitioning a UE between states of a protocol for controlling radio resources between the UE and the RAN.

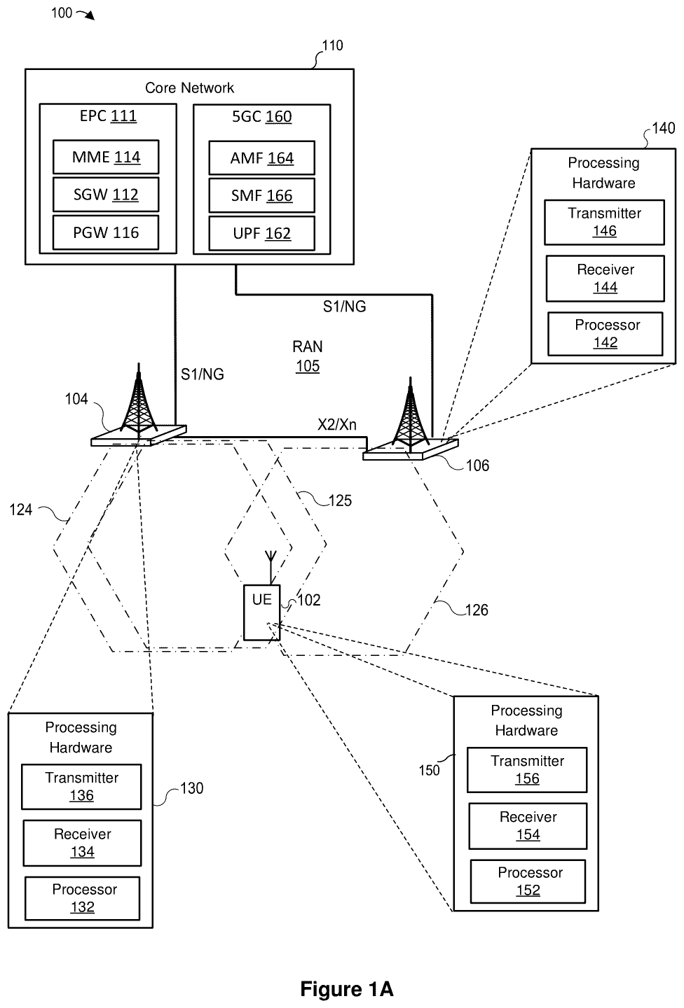

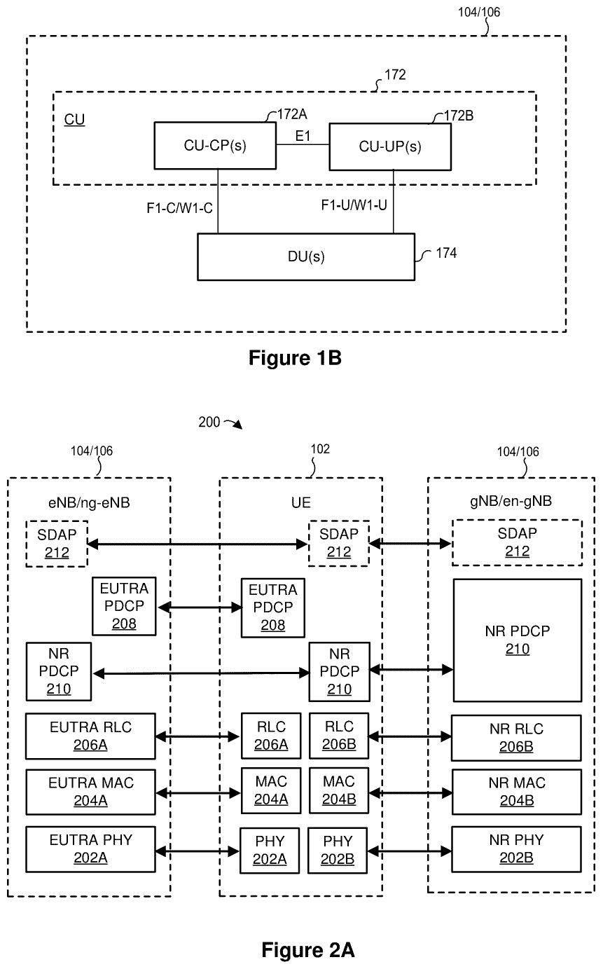

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a processor 132 to process data that the base station 104 will transmit in the downlink direction, or process data received by the base station 104 in the uplink direction. The processing hardware 130 can also include a transmitter 136 configured to transmit data in the downlink direction. The processing hardware further can include a receiver 134 configured to receive data in the uplink direction. The base station 106 can include generally similar components. In particular, components 140, 142, 144, and 146 of the base station 106 can be similar to the components 130, 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transmitter 156 configured to transmit data in the downlink direction. The processing hardware further can include a receiver 154 configured to receive data in the uplink direction.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

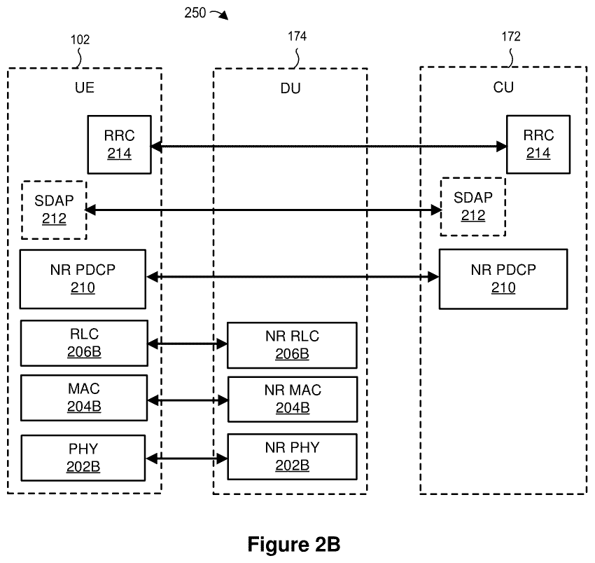

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

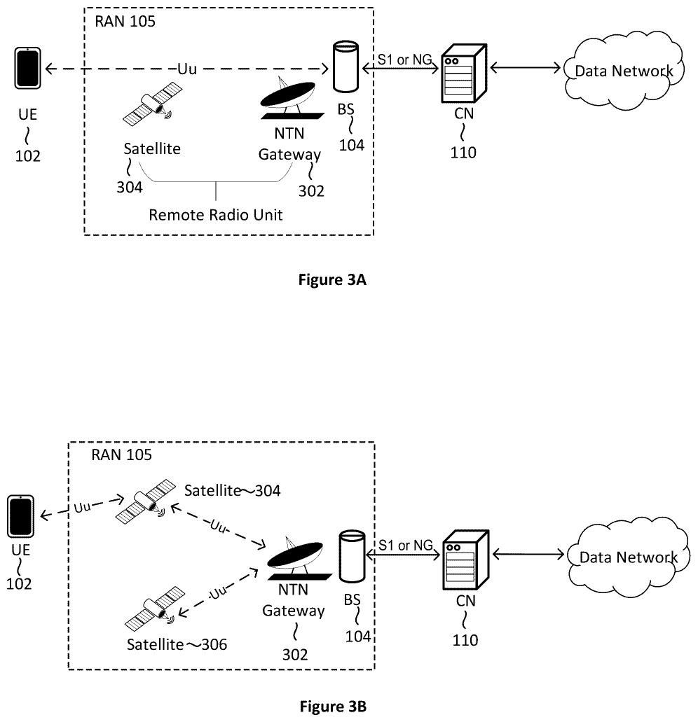

FIG. 3A illustrates a certain type of NTN deployment referred to as transparent payload architecture, which involves a satellite gateway 302 and a “transparent” satellite 304 for extending the range of the Uu interface. The satellite 304 implements a frequency conversion and a Radio Frequency (RF) amplifier in both the uplink and downlink directions. The satellite function is similar to that of an analogue RF repeater. As a result, the satellite 304 repeats the Uu radio interface from the feeder link (between the NTN gateway and the satellite) to the service link (between the satellite and the UE) in the downlink direction and vice versa in the uplink direction. The Satellite Radio Interface (SRI) on the feeder link is the Uu, and the NTN gateway 302 supports all necessary functions to forward the signal of the Uu interface. The NTN gateway 302 can be placed at the same site as the base station (e.g., eNB, gNB) 104 location, or be connected to the base station 104 at a distance via a wired link. It is also possible to connect more than one NTN gateway to a base station. Different transparent satellites may be connected to the same base station on the ground, via the same NTN gateway, or via different NTN gateways. FIG. 3B illustrates the case where two different satellites (304 and 306) are connected to the same base station 104 via the same NTN gateway 302, and these two satellites (304 and 306) are covering the Earth surface using two different Physical Cell IDs (PCIs).

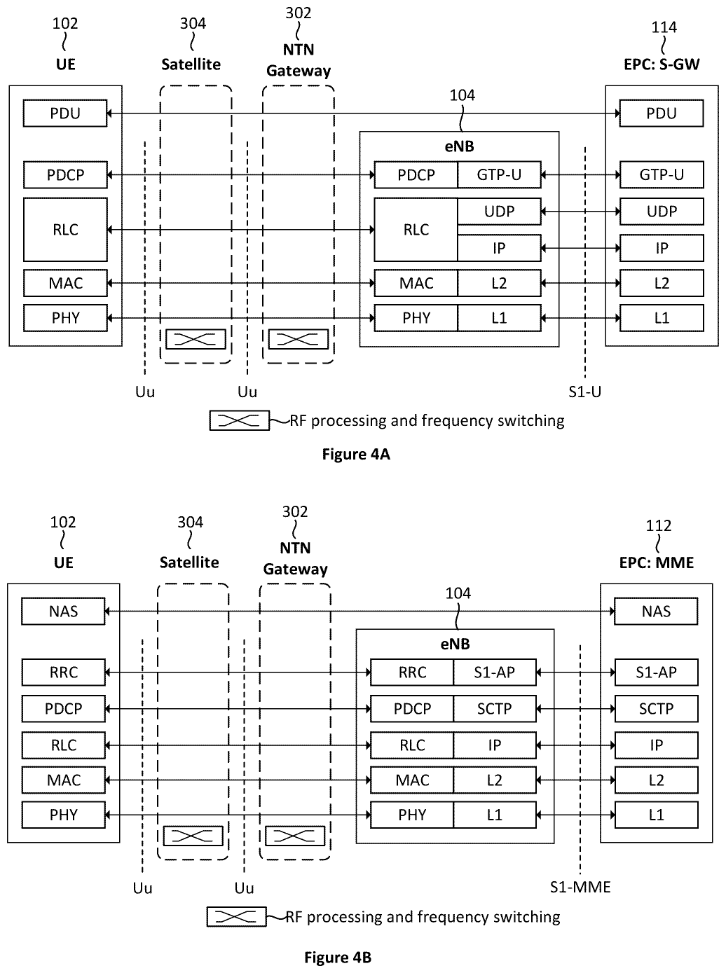

The NTN user plane protocol stack involving the UE 102, satellite 304, NTN gateway 302, the BS 104 and the S-GW 114 is illustrated in FIG. 4A. The diagram of the NTN user plane protocol stack is similar to that of the terrestrial network (TN), with the addition of two new nodes, the satellite 304 and the NTN gateway 302, being placed in the middle of the Uu interface. Similarly, the NTN control plane protocol stack illustrated in FIG. 4B is also similar to that of the terrestrial network.

In terms of the satellite moving pattern, there are three types of service links that are supported in NTN:
Earth-fixed: provisioned by beam(s) continuously covering the same geographical areas all the time (e.g., the case of GEO/GSO satellites)
Quasi-Earth-fixed: provisioned by beam(s) covering one geographic area for a limited period and a different geographic area during another period (e.g., the case of LEO/MEO satellites capable of using steerable beams)
Earth-moving: provisioned by beam(s) whose coverage area slides over the Earth surface (e.g., the case of LEO/MEO satellites using fixed or non-steerable beams).

With LEO/MEO satellites, the eNB can provide either quasi-Earth-fixed cell coverage or Earth-moving cell coverage. With GEO satellites, the eNB can provide Earth fixed cell coverage.

Although the transparent payload architecture illustrated in FIGS. 3A/3B is the current focus of the 3GPP development, the regenerative payload architecture that installs the eNB functions on the satellite is also a possible NTN deployment in the future. In such an architecture, the Uu only exists between the satellite and the UE. In general, the techniques of this disclosure can apply to the transparent payload architecture as well as the regenerative payload architecture.

Extended Discontinuous Reception (eDRX) is an extension of the DRX feature that is used by IoT or MTC devices to further reduce power consumption. With the DRX mechanism, a user device can go into a sleep mode for a certain period and then wake up after the sleep period to monitor the DL signal from the base station. The DRX cycle defines the time interval between two consecutive time periods when the UE is awake. The eDRX enhancement is to extend the DRX cycles to allow a device to remain in the sleep mode for a longer period of time. The eDRX enhancement can be used with or without power save mode (PSM) to achieve additional power savings. eDRX was developed by the standardization body 3GPP and introduced since 3GPP Rel-13.

In one example, a typical LTE device can be configured with a paging cycle (i.e., DRX cycle) of up to 2.56 seconds. With such a configuration, the UE wakes up and monitors paging from the network every 2.56 seconds, during a paging occasion (PO) in a paging frame (PF). On the other hand, an LTE device that supports eDRX can be configured with an eDRX cycle of up to 2621.44 seconds, which allows the device to wake up for one Paging Time Window (PTW) every 2621.44 seconds. Therefore, an LTE device supporting the eDRX feature can consume much less power compared to devices that do not support this feature. Moreover, an NB-IoT device (which supports eDRX by default) can be configured with an eDRX cycle of up to 10485.76 seconds, which allows the device to wake up once every 2.9 hours, and hence the NB-IoT device can save even more power compared to the LTE device supporting eDRX. A device supporting the eDRX feature does not need to wake up for the entire PTW, which ranges from 1.28 seconds to 20.48 seconds, but only wakes up at the paging occasions determined by the legacy DRX configuration/parameters inside the PTW.

The UE and the network (e.g., the MME) negotiate DRX and eDRX parameters using the following messages: Attach Request, Attach Accept, Tracking Area Update Request, and Tracking Area Update Accept. During the attach procedure, the UE provides the preferred values of the DRX and eDRX parameters in the Attach Request message, and the network provides the final values of these parameters in the Attach Accept message. The UE can transmit an Attach Complete message to the network in response to the Attach Accept message.

Similarly, during the Tracking Area Update (TAU) procedure, the preferred values of the DRX and eDRX parameters are provided by the UE in the Tracking Area Update Request message, and the final values of these parameters are provided by the network in the Tracking Area Update Accept message. The UE can transmit a TAU Complete message to the network in response to the TAU Accept message. In case of the DRX configuration for non-NB-IoT devices, the network will only accept or reject the preferred DRX configuration set by the UE in the Attach Request/Tracking Area Update Request, and will not provide the revised configuration in the Attach Accept/Tracking Area Update Accept message.

The DRX cycle length can be configured from the following values: {320 ms, 640 ms, 1280 ms, 2560 ms}. For an NB-IoT device, The PTW length can be configured from the following values: {2.56 s, 5.12 s, 7.68 s, 10.24 s, 12.8 s, 15.36 s, 17.92 s, 20.48 s, 23.04 s, 25.6 s, 28.16 s, 30.72 s, 33.28 s, 35.84 s, 38.4 s, 40.96 s}, and the eDRX cycle length can be configured from the following values: {5.12 s, 10.24 s, 20.48 s, 40.96 s, 61.44 s, 81.92 s, 102.4 s, 122.88 s, 143.36 s, 163.84 s, 327.68 s, 655.36 s, 1310.72 s, 2621.44 s, 5242.88 s, 10485.76 s}. It should be noted that if the eDRX cycle length is configured as 5.12 s, there will be no PTW for the UE and the UE will just perform the legacy DRX operation with the DRX cycle length equal to 5.12 s.

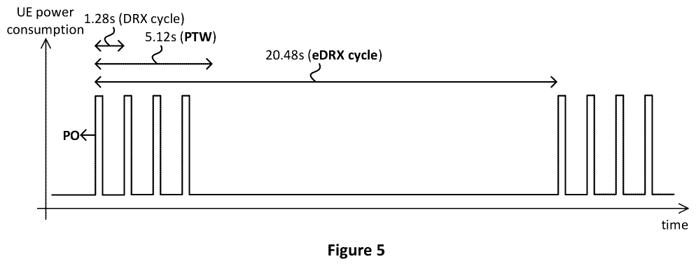

FIG. 5 illustrates an example in which a UE is configured with the eDRX cycle equal to 20.48 seconds, the PTW equal to 5.12 seconds, and the DRX cycle equal to 1.28 seconds. In this example, the UE is configured to wake up 4 times in a PTW (each a paging occasion (PO)), in order to monitor for the paging message. Except for the PTW, the UE can completely turn off its radio module for approximately 15.36 seconds per eDRX cycle and thus save a significant amount of power.

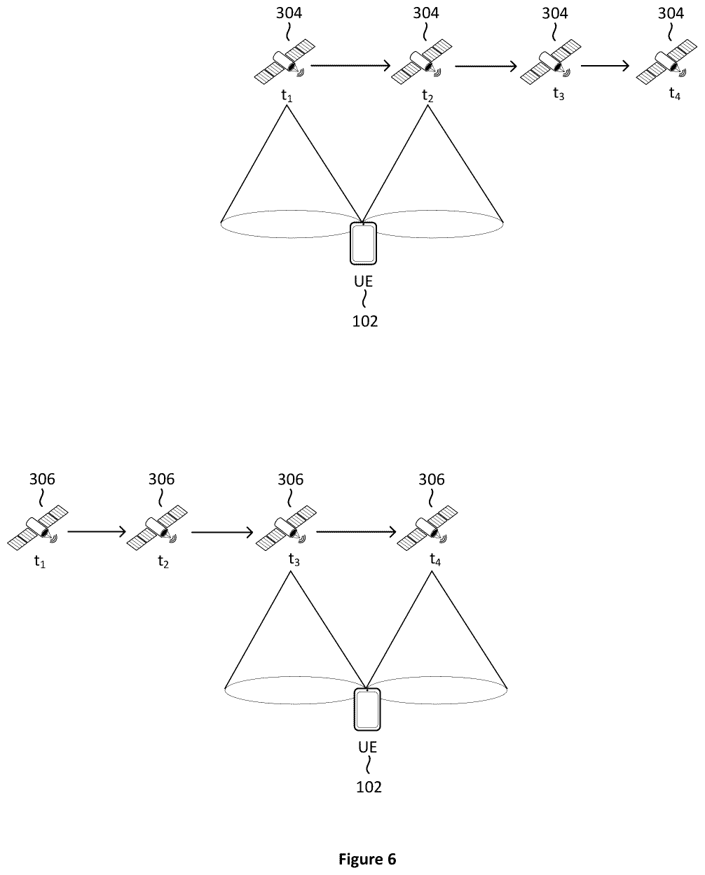

FIG. 6 illustrates an example scenario in which the UE 102 is served by the LEO satellite 304 from t1 to t2, and served by another LEO satellite 306 from t3 to t4. In the period between t2 to t3, the UE 102 is not served by any satellite or any terrestrial base station and therefore is out of coverage. Typically, when a UE loses coverage by the serving cell, the UE starts searching for other cells and then camps on a suitable cell. However, in the example illustrated in FIG. 6, even if the UE 102 starts searching for other cells immediately after t2, the UE cannot find a cell, and therefore the search for other cells results in the UE only expending power. To optimize power consumption at the UE in particular NTN scenarios such as the one depicted in FIG. 6, the UE may not be required to perform the cell search and can deactivate the Access Stratum (AS) functions during the period when the UE is not within the area of coverage of a satellite.

However, doing so would require the UE to have the knowledge of when the UE will be outside the area of coverage, and when the UE will be within an area of coverage again, in order to activate its cell search or AS functions again before the UE falls into the coverage of another NTN cell. The ephemeris information broadcasted in the system information provides the constellation and trajectory/movement information of the serving and the neighboring satellites, which helps UE to predict/estimate when it will be within and when it will be outside the NTN coverage. However, relying on only the ephemeris information may not be sufficient for a UE to estimate/predict the coverage, as not every satellite projects its beams/cells onto the Earth perpendicularly and have the same sizes of the coverage. Some other information may be required for the UE to estimate/predict the coverage of the NTN cell more precisely.

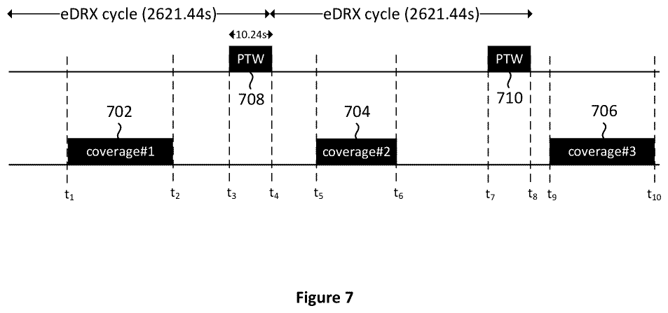

FIG. 7 illustrates an example in which aUE is configured with a eDRX cycle equal to 2621.44 seconds and with the PTW length equal to 10.24 seconds. The UE is within the period of coverage 702 of an Earth-moving cell controlled by the first satellite from t1 to t2, within the period of coverage 704 of another Earth-moving cell controlled by the second satellite from t5 to t6, and again within the period of coverage 706 of the Earth-moving cell controlled by the first satellite from t9 to t10. Except for these intervals, the UE has no satellite coverage or TN coverage. The UE wakes up and monitors the paging during the PTW 708, starting at t3 and ending at t4, but the UE in this scenario cannot detect any signals, as none of the satellites provide coverage to the UE during this time period. As a result, it may take much longer than expected to reach a UE configured with the eDRX in the discontinuous coverage scenario, as compared to a continuous coverage scenario or a scenario involving a terrestrial network. It is even possible that the network cannot page the UE configured with eDRX at all in a discontinuous coverage scenario, if none of the PTWs falls within the coverage period of any satellite. The techniques discussed below address these concerns.

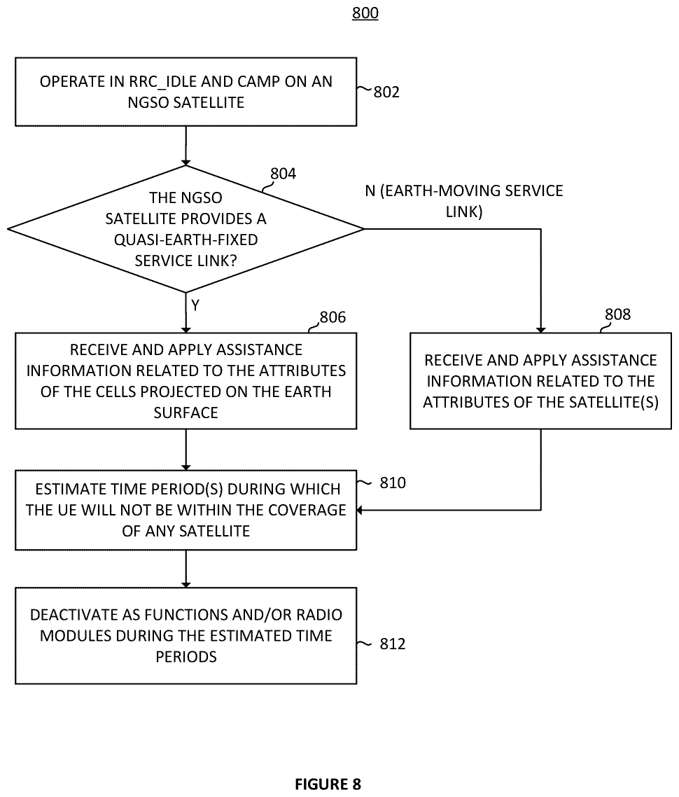

FIG. 8 is a flow diagram of an example method 800 that can be implemented by an UE (e.g., UE 102 in this disclosure) for estimating the periods of discontinuous coverage. Initially, at block 802, the UE is in the RRC_IDLE state and camps on an NGSO satellite. Then, at block 804, the UE determines the type of a service link (e.g., quasi-Earth-fixed or Earth-moving) the NGSO satellite provides. Generally speaking, a quasi-Earth-fixed service link resides on a beam that covers one geographic for a certain period of time and then jumps to another geographic area for another period of time. On the other hand, an Earth-moving service link resides on a beam whose coverage area slides over the surface of the Earth. The UE can determine movement pattern of the NGSO satellite based on the received satellite ephemeris information, the received system information, or the received NAS information, for example.

When the NGSO satellite provides a quasi-Earth-fixed service link, the UE can expect to receive, from the NTN, assistance information related to the attributes of the cell projected onto the surface of the Earth (block 806). This type of assistance information can be referred to as below as “NTN cell-related assistance information.” When the NGSO satellite provides an Earth-moving service link, the UE can expect to receive, from the NTN, assistance information related to the attributes of the satellite (block 808), referred to below as “satellite-related assistance information”. When the NTN provides both NTN cell-related assistance information and satellite-related assistance information, or when the UE has otherwise obtained both types of assistance information, the UE can determine which set of attributes to use based on the type of the service link (e.g., Earth-moving or quasi-Earth-Fixed) the UE is currently using to communicate with the serving satellite.

At block 810, the UE can estimate time periods during which the UE will lack satellite coverage, based on the attributes selected and applied at block 806 or block 808. Because the UE is likely to also lack terrestrial network (TN) coverage, these time periods can be understood as periods of discontinuous coverage. Based at least in part on the results of estimation at block 810, the UE may deactivate the AS functions and/or the radio modules during the periods of discontinuous coverage (block 812).

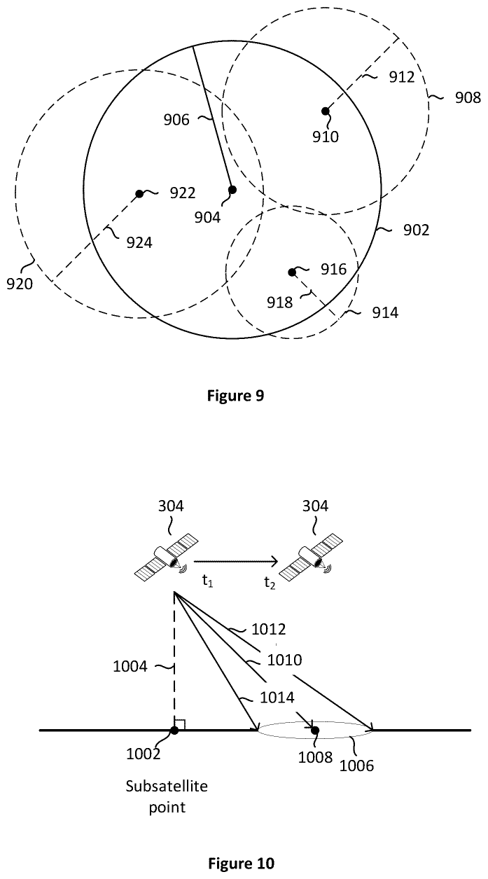

For further clarity, FIG. 9 illustrates an example application of an NTN cell-related assistance information. This type of assistance information can contain information related to the serving cell 902, e.g., an indication of the time when the cell 902 will no longer serve a certain geographic area, the central coordinate 904 of the serving cell 902, and the radius 906 of the serving cell 902. The NTN cell-related assistance information may also contain information related to one or more neighboring or “upcoming” (in terms of future service) cells. For the example upcoming cells 908, 914, and 920, this information can indicate the time when the cell will start serving the geographic area (“start time”) and the time when the cell will stop serving the geographic area (“stop time”). The information related to an upcoming cell may further indicate the central coordinates of the cells (e.g., the coordinates 910, 916, and 922) as well as the radii of the cells (e.g., the radius 912, 918, and 924).

As illustrated in FIG. 9, the central coordinate and the radius together define a specific geographic area, and the UE may need to obtain and use its GNSS coordinate information to determine whether the UE will be within the geographic area defined by the central coordinate and the radius. If the information for an upcoming cell contains only the start and the stop times, the UE may interpret this format as an indication that the upcoming cell provides the same geographic coverage as the service cell. In this case, the UE (when stationary) can determine that it will certainly be within the coverage area of the upcoming cell, even without obtaining and using its GNSS coordinate information.

In the discussion above, it is assumed that each cell is a circular cell, and therefore the central coordinate and cell radius precisely define cell geometry. However, these cells in other scenarios can be non-circular (e.g., rectangular, elliptical, hexagonal). In these cases, the NTN cell-related assistance information can specify the focus point rather than the central coordinate, and specify the semi-minor axis, the semi-major axis, the diameter, the width and/or length, etc. instead of the radius.

FIG. 10 illustrates an example application of a satellite-related assistance information. This information can contain for example satellite constellation information (i.e., satellite ephemeris information) of the serving satellite and the neighboring or upcoming satellites, which the UE and/or the serving satellite can use to determine different positions at different times, for a certain satellite. Assuming for example that the satellite 304 projects its beam onto the surface of the Earth perpendicularly at a sub-satellite point 1002, and that the UE has the relevant satellite ephemeris information as well as the radius of the Earth-moving cell, the UE can determine the geographic area of the Earth-moving cell. However, the satellite 304 in many situations may project its beam with a non-zero (i.e., non-perpendicularly) antenna panel tilt onto the surface, which makes the reference point 1008 the central coordinate of the Earth-moving cell at time t1. Thus, in addition to the satellite ephemeris information and the cell radius, the base station may also need to provide the angle of the antenna panel tilt to the UE, so that the UE can determine the geographic area of the Earth-moving cell corresponding to the satellite.

In the example illustrated in FIG. 10, the antenna panel tilt provided by the base station is the angle spanned by line 1010 and line 1004, which can be denoted by θ. Instead of providing the cell radius, the base station may provide the minimum antenna panel tilt (denoted by θₘᵢₙ), which is spanned by line 1014 and line 1004, and the maximum antenna panel tilt, (denoted by θₘₐₓ), which is spanned by line 1012 and 1004. Using the satellite ephemeris information, θ, θₘᵢₙ, and θₘₐₓ, the UE can determine the geographic area of the Earth-moving cell corresponding to the satellite.

Referring back to FIG. 8, the UE in some cases should not deactivate the AS functions and/or the radio modules during the estimated periods of discontinuous coverage (see block 812) if the UE can camp on a TN cell during the periods of discontinuous coverage. In some cases, an NTN base station signals availability of a TN cell in the system information. The signaling can be a binary indication indicating whether there is a TN cell within the coverage area of the serving NTN cell, or a more detailed indication including the position and size of the TN cell(s) deployed within the coverage of the serving NTN cell. The UE, upon receiving such an indication and in view of the current position of the UE, may determine whether to deactivate the AS functions and/or the radio modules during the periods of discontinuous coverage, as an alternative to block 812.

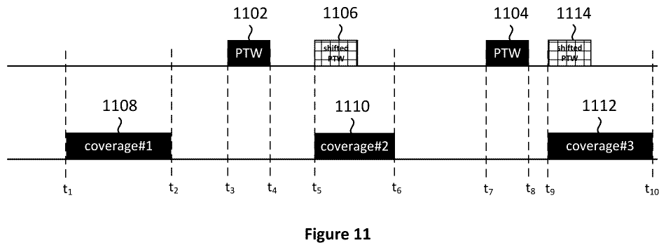

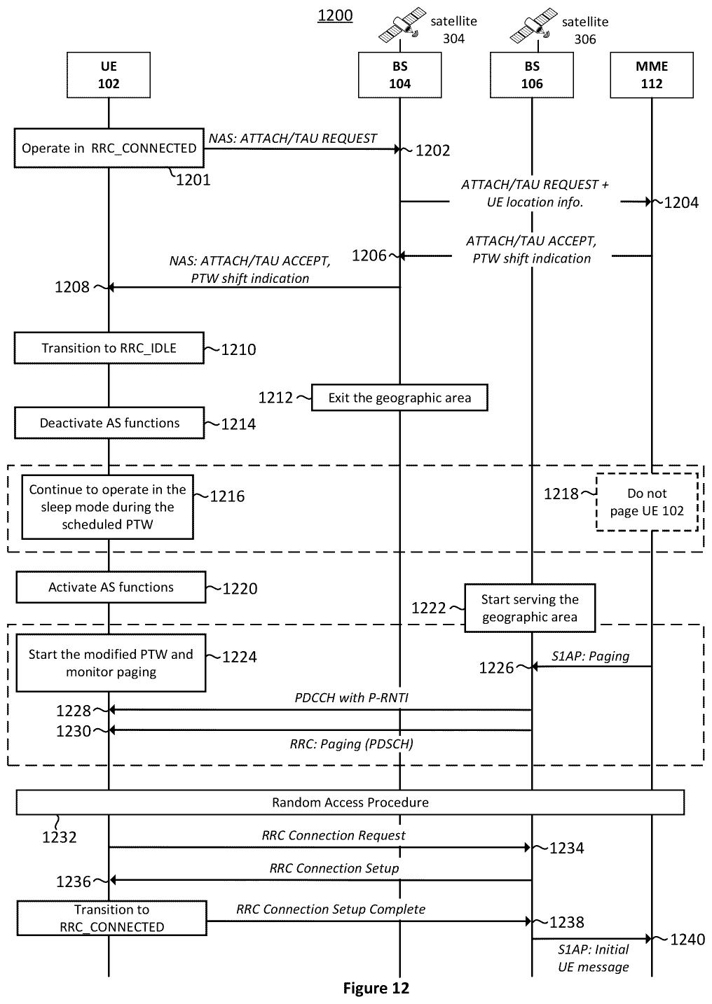

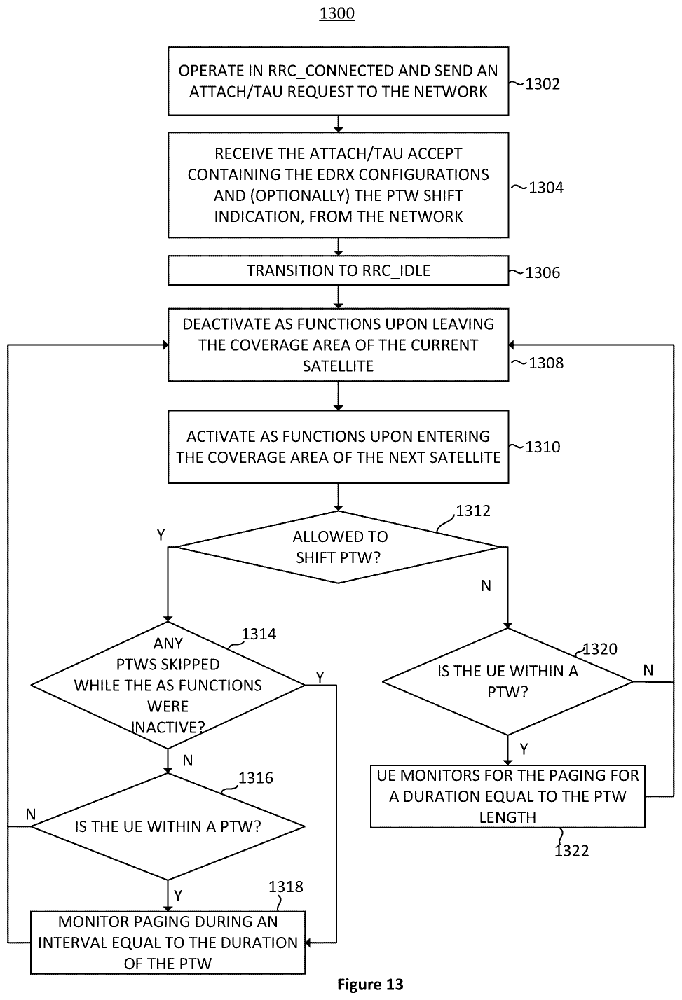

Next, FIG. 11 illustrates an example scenario in which a UE and an NTN modify a PTW by shifting and aligning the PTW with a period of satellite coverage, and the UE accordingly can receive paging messages during the modified PTW. This approach is further discussed with reference to the messaging diagram of FIG. 12 and the flow diagram of FIG. 13.

The UE obtains the original PTW configuration including PTWs 1102 and 1104. However, the UE estimates that it will be within the coverage areas of NTN cells during time periods 1108, 1110, and 1112. Outside these time periods, the UE turns off the AS functions and/or the radio modules to save power, and does not monitor paging during the scheduled PTWs 1102 and 1104. In order to reach the UE in connection with a mobile-terminated (MT) event, the network (e.g., MME) may need to send a paging message to the UE during the periods when the UE has activated the AS functions and/or radio modules (i.e., during the period 1108, 1110, and 1112), and the UE accordingly needs to monitor paging during these periods.

The network can schedule the paging and cause the UE to monitor paging during the PTW 1106, shifted in time relative to the originally configured PTW 1102. The duration of the PTW 1106 may be equal to the duration of the PTW 1102. The UE can refrain from monitoring of paging messages during the PTW 1102 and instead operate in the sleep mode during the originally configured PTW 1102. The start time of the PTW 1106 can substantially coincide with time t5 when the UE enters (or projects entering) the period of coverage 1110.

In another implementation or scenario, the network and the UE shift the PTW backward in time toward the period 1108 preceding the originally configured PTW 1102, rather than forward in time to the period 1110 as discussed above. The start time of the PTW 1106 in this case can substantially coincide with time t1 when the UE enters (or projects entering) the period of coverage 1108.

For both implementations, the UE and the network should have the same understanding of whether the PTW can shift to align, or at least partially overlap with, a period of satellite coverage, and whether the PTW shifts forward or backward relative to the original PTW timing. In order to ensure the UE and the network apply the same PTW management logic, the base station can broadcast a PTW shift indication in the system information, for example. The PTW shift indication can indicate whether the scheduled PTW can shift, and/or whether the shift is in the forward-in-time or backward-in-time direction. In one example implementation, absence of an explicit PTW shift indication signals default UE behavior, which can include applying the originally configured PTW, or applying the forward-in-time shift to the PTW when applicable.

FIG. 12 is a messaging diagram of an example scenario in which the UE 102 and one or more network nodes align the PTW timing with a time period when the UE 102 has satellite coverage, as discussed above with reference to FIG. 11. The UE 102 initially operates 1201 in the RRC_CONNECTED state, e.g., the UE connects to the BS 104 via the service link provided by the satellite 304. Initially, the UE 102 transmits 1202 a NAS message such as ATTACH REQUEST or TAU REQUEST to the BS 104, and then the BS 104 forwards 1204 the ATTACH REQUEST or TAU REQUEST message to the MME 112. The UE 102 can provide preferred values of the DRX and eDRX parameters in the ATTACH REQUEST or TAU REQUEST message, and the MME 112 selects values for these parameters and indicates 1206 these values in the ATTACH ACCEPT or the TAU ACCEPT message. When the BS 104 forwards 1204 the ATTACH REQUEST or TAU REQUEST message to the MME 112, it may also provide the position/location information of the UE 102 to the MME 112. The UE 102 may send its location/position information to the BS 104 during the initial access procedure or during the measurement report procedure (not shown). In response to the ATTACH REQUEST or TAU REQUEST message from the UE 102, the MME sends 1206 the ATTACH ACCEPT or TAU ACCEPT message to the BS 104, and the BS 104 then forwards 1208 the ATTACH ACCEPT or the TAU ACCEPT message to the UE 102.

In this scenario, the MME 112 also includes, in the ATTACH ACCEPT or the TAU ACCEPT message, a PTW shift indication indicating that the UE 102 shall shift the PTW, if the UE 102 is not within the coverage of any satellite during the scheduled PTW. In this example, the PTW shift indication corresponds to a forward-in-time shift by default.

Sometime after receiving the ATTACH ACCEPT or the TAU ACCEPT message, the UE 102 transitions 1210 to the RRC_IDLE state. In some implementations, the UE 102 starts an inactivity timer, and after receiving the ATTACH ACCEPT or TAU ACCEPT message, the UE 102 transitions 1210 to the RRC_IDLE state in response to the expiration of the inactivity timer. In other implementations, after receiving the ATTACH ACCEPT or TAU ACCEPT message, the UE receives an RRC Connection Release message from the BS 104 via the satellite 304 and, in response, transitions 1210 to the RRC_IDLE state.

At a later time, the UE 102 in the RRC_IDLE state is no longer within the service area of the satellite 304 because the satellite 304 has moved 1212 to a new position and is no longer able to provide coverage for the UE 102. In some implementations, the UE 102 can estimate/predict the time when the satellite 304 will no longer provide coverage to the UE 102, and the time when the upcoming satellite (satellite 306 in this example) will start providing coverage to the UE 102. During the period between these two times, the UE 102 deactivates 1214 its AS functions and/or its radio modules to save power. The UE 102 then activates 1220 its AS functions and/or its radio modules again when the satellite 306 starts 1222 serving the area. If the PTW occurs during the period when the UE 102 has deactivated the AS functions and/or the radio modules, the UE 102 refrains 1216 from monitoring the original PTW. The UE 102 in other words skips 1216 the PTW and continues to operate in the sleep mode.

Further, in the example scenario of FIG. 12, the MME 112 receives an MT call for the UE 102, prior to or during the scheduled PTW. The MME 112 determines that that the UE 102 is not within the coverage of any satellite based on the UE location/position information and the satellite ephemeris information, and, accordingly determines not to page 1218 the UE 102.

After the satellite 306 starts 1222 serving the area, the UE 102 also starts 1224 monitoring paging during the modified PTW, which has the same duration as the originally scheduled PTW but a different start time. Because the MT event for the UE 102 is still pending in this scenario, the MME 112 sends 1226 a Paging message to the eNB 106 through the S1-MME interface, and then the eNB 106 notifies 1228 the UE 102 of the scheduling of the paging message over the PDCCH using the Paging Radio Network Temporary Identifier (P-RNTI). The eNB 106 then broadcasts 1230 the Paging message with the identity (i.e., S-TMSI or IMSI) of the UE 102 at the scheduled time and frequency resource over the PDSCH.

The UE 102 receives the Paging message containing the identity of the UE and attempts to establish an RRC connection by initiating 1232 a Random Access (RA) procedure with the eNB 106. Following the RA procedure, the UE 102 transmits 1234 an RRC Connection Request message to the eNB 106, and then the eNB 106 responds 1236 with an RRC Connection Setup message. Upon receiving the RRC Connection Setup message, the UE 102 transitions to the RRC_CONNECTED state and transmits 1238 the RRC Connection Setup Complete message containing the ATTACH REQUEST (NAS message) to the eNB 106. The eNB 106 subsequently transmits 1240 an Initial UE message in response to the Paging message from the MME 112, where the Initial UE message contains the ATTACH REQUEST (NAS message) from the UE 102.

FIG. 13 is a flow diagram of an example method 1300 which the UE 102, or another suitable UE, implements to determine whether to shift the PTW, and by how much. According to this method, a modified PTW is of the same duration as the originally configured PTW, but shifted forward or backward in time relative to the originally configured PTW.

At block 1302, the UE operates 1201 with an established RRC connection between the UE and an eNB operating in NTN, and sends 1202 the ATTACH REQUEST or TAU REQUEST message containing the preferred eDRX configurations to the MME. At block 1304, the UE receives 1208, from the network, the ATTACH ACCEPT or the TAU ACCEPT message including the confirmed eDRX configuration(s) as well as the PTW shift indication. At block 1306, the UE transitions 1210 to the RRC_IDLE state and applies the eDRX configuration(s), so that the network can reach the UE via paging during certain periodically occurring time windows. The UE at block 1308 deactivates 1214 its AS functions and/or its radio modules upon leaving the coverage of the current satellite (due to the satellite movement) at block 1308, when the UE is capable of estimating the pattern of discontinuous coverage using NTN cell-related assistance information or satellite-related assistance information. At block 1310, the UE determines that it has entered the area of coverage of the next satellite and reactivates 1220 the AS functions and/or its radio modules, so as to perform the necessary idle mode operations such as conducting measurement and evaluating cell reselection criteria.

At block 1312, the UE determines whether a shift of the PTW is allowed. When the PTW shift indication received in block 1304, or the default configuration of the UE, indicates that the UE shall shift the PTW to a later timing whenever the UE is not within the coverage of any satellite within the scheduled PTW, the flow follows the ‘Y’ branch. At block 1314, the UE determines whether it has skipped any PTWs while the AS functions and/or its radio modules of the UE were inactive. If the UE has skipped at least one PTW, the flow proceeds to block 1318 to monitor 1224 paging during the modified PTW, which can be a time interval of a duration equal to the duration of the originally configured PTW. However, if the UE did not skip any PTWs, the flow proceeds to block 1316, where the UE determines whether there is or will be any instances of the PTW during the period when the UE has activated its AS functions and/or radio modules. The flow proceeds to block 1318 if such a PTW exists. Otherwise, the flow returns to block 1308, where the UE can deactivates its AS functions and/or radio modules upon leaving the coverage of the current satellite. In at least some of the implementations, after the UE completes the monitoring of paging at block 1318, the UE deactivates its AS functions and/or radio modules (e.g., by returning to block 1308), if the UE determines that the network has not paged the UE.

Referring again to block 1312, when the PTW shift indication received in block 1304, or the default behavior of the UE, indicates that the UE shall not shift the PTW, the flow proceeds to block 1320, similar to block 1316, where the UE only needs to check whether there is or will be any PTW instances during the period when the UE turns on its AS and/or radio modules. The flow proceeds to block 1322 if such a PTW exists, and the UE monitors paging during the PTW similar to block 1318. Otherwise, the flow returns to block 1308. In at least some of the implementations, after the UE completes the monitoring of paging at block 1322, the UE deactivates its AS functions and/or radio modules (e.g., by returning to block 1308), if the UE determines that the network has not paged the UE

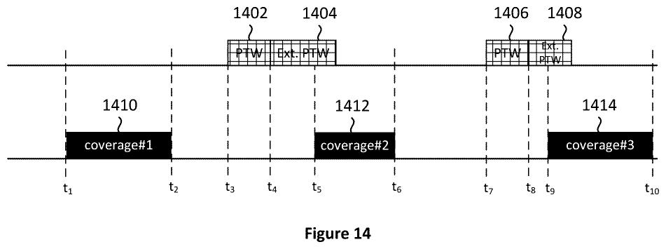

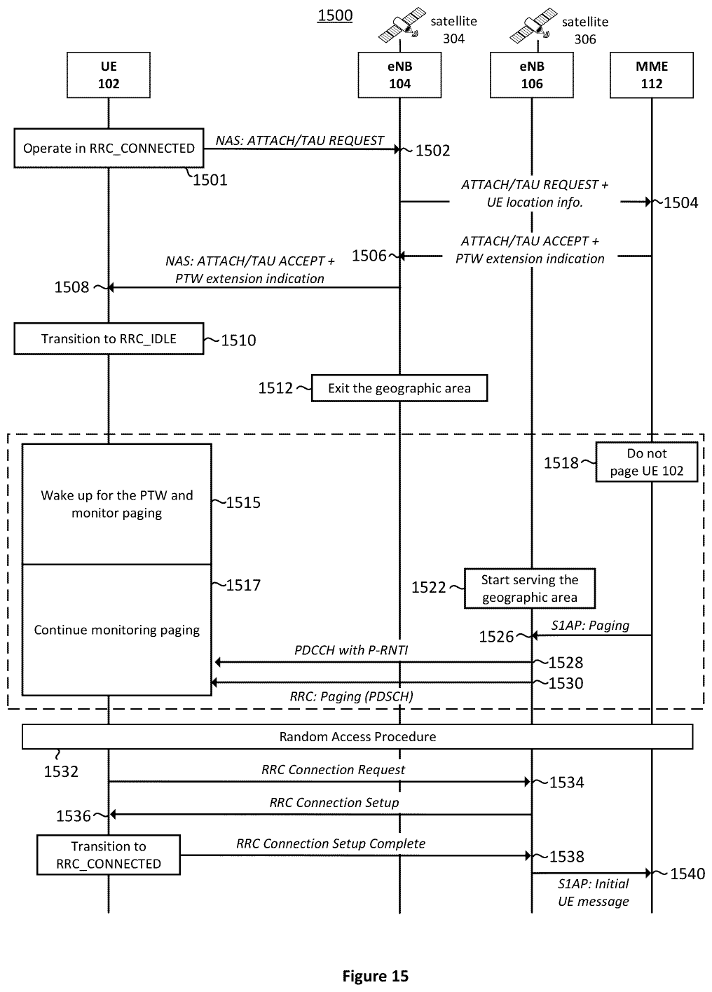

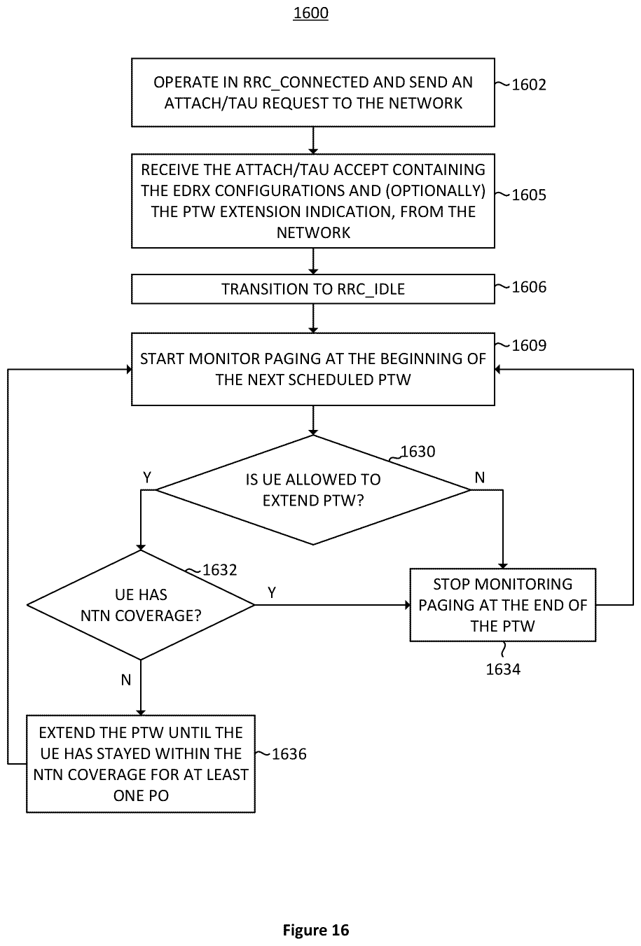

Now referring to FIG. 14, in this scenario a UE and an NTN modify a PTW by extending the PTW so as to overlap a period of satellite coverage, and the UE accordingly can receive paging messages during the modified PTW. This approach is further discussed with reference to the messaging diagram of FIG. 15 and the flow diagram of FIG. 16.

The UE wakes up and monitors paging during the first initially configured PTW 1402. However, because the UE is not within the area of coverage of any satellite during the entire PTW 1402, the UE extends the PTW by an extension period 1404, so that the extended PTW 1404 can overlap with the period of coverage 1412, when the UE can receive paging messages from the second satellite. The UE stops the extended PTW when at least one of UE's paging occasions (POs) is within the period of coverage 1412. If there is a pending MT event for the UE, the network (i.e., MME) can page the UE starting at the earliest PO that falls within the period of satellite coverage 1412. Similarly, the UE wakes up and monitors the paging during the second initially configured PTW 1406. Because the UE is not within the area of coverage of any satellite during the entire PTW 1406, the UE extends the PTW by an extension period 1408. The UE stops the extended PTW when at least one of the POs for the UE is within the period of coverage 1414. The network can page the UE starting at the earliest PO that falls within the period of satellite coverage 1414, if there is a pending MT event for the UE.

In order to ensure the UE and the network apply the same PTW extension logic, the base station can broadcast an indication in the system information, which indicates whether the scheduled PTW can be extended. Depending on the implementation, presence of a PTW extension indication can signal that the UE is allowed to extend the originally configured PTW or, conversely, presence of the PTW extension indication can signal that UE is not allowed to extend the originally configured PTW.

FIG. 15 is a messaging diagram of an example scenario 1500 in which the UE 102 and one or more network nodes extend the PTW timing, as discussed above with reference to FIG. 14. Events 1501-1512 are generally similar to the events 1201-1212 of FIG. 12, except that here the MME 112 generates 1506, and the BS 104 forwards 1508, a PTW extension indication, rather than a PTW shift indication, to modify a PTW.

In this scenario, UE 102 may lack the knowledge that no satellite coverage is available during the initially configured PTW (unlike the scenario of FIG. 12, where the UE can use an NTN cell-related assistance information or a satellite-related assistance information to estimate the period of non-coverage and remain in the sleep mode). Accordingly, the UE wakes up and monitors paging 1515 starting with the beginning of the initially configured (or “scheduled”) PTW, but cannot receive PDCCH or other DL signaling, because the UE is not within the area of coverage of any satellite during the entire originally configured PTW.

However, in this implementation, the MME 112 can use the location/position information of the UE 102 and the satellite ephemeris information to determine that the UE 102 is not within the area coverage of any satellite, and accordingly refrain 1518 from paging the UE 102, even if there is a pending MT event.

After the originally configured PTW ends, the UE 102 extends the PTW and continues 1517 to monitor paging. Shortly after the beginning of the extended PTW, another satellite 306 moves in and starts 1522 serving the geographic area where the UE 102 is currently located. When there is a pending MT event related to the UE 102, the MME 112 can determine that the UE 102 now has NTN coverage. The MME 112 accordingly starts paging the UE 102. Events 1526-1540 are similar to the events 1226-1240 discussed above.

FIG. 16 is a flow diagram of an example method 1600, which can be implemented by the UE 102 or another suitable UE. The UE may not be capable of estimating/predicting the pattern of discontinuous coverage; however, the UE can extend the PTW using this method. According to this method, a modified PTW can start at the same time as the originally configured PTW, but does not end at the same as the originally configured PTW.

The method 1600 begins at block 1602, which is similar to block 1302 in the method 1300 discussed above. Block 1605 is generally similar to block 1304, except that the network provides a PTW extension indication, rather than a PTW shift indication, to instruct the UE to modify the PTW. After block 1606, which is similar to block 1306, the UE at block 1609 starts monitoring paging at the beginning of the next scheduled PTW.

At block 1609, the UE wakes up and starts to monitor paging from the start time of the originally configured PTW. If the UE has not received a PDCCH signal addressed to the UE with a P-RNTI by the end of the originally configured PTW, the UE determines at block 1630 whether the UE is allowed to extend the PTW.

If the PTW extension indication received in block 1604 or the default UE configuration indicates that the UE shall extend the PTW if the UE is not within the coverage of any satellite in the scheduled PTW, the flow proceeds to block 1632 to determine whether the UE currently has NTN coverage. In case the UE currently has NTN coverage, and the UE did not detect paging messages during any of the POs, the UE stops monitoring paging after the current PTW completes (block 1634). However, when the UE has no the NTN coverage, or when the UE will not remain in the NTN coverage area sufficiently long for at least one of the POs, the UE extends the current PTW until the UE has stayed within a period of NTN coverage for at least one PO (block 1636).

On the other hand, if the PTW extension indication received in block 1604, or the default UE configuration, indicates that the UE cannot extend the originally configured PTW, the flow proceeds from block 1630 to block 1634, and the UE stops monitoring paging when the current PTW ends.

If the network does not page the UE because there is no pending MT event, for example, the UE continues to operate in RRC_IDLE after executing block 1634 or block 1636. Thus, the flow can return to block 1609, and the UE can remain in RRC_IDLE and wait for the start of the next PTW.

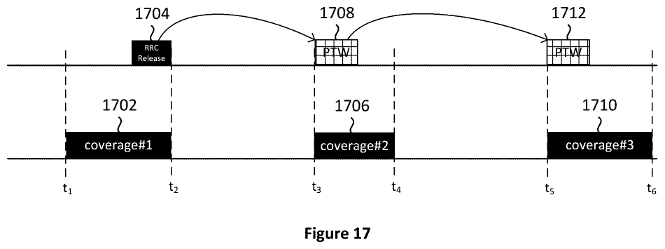

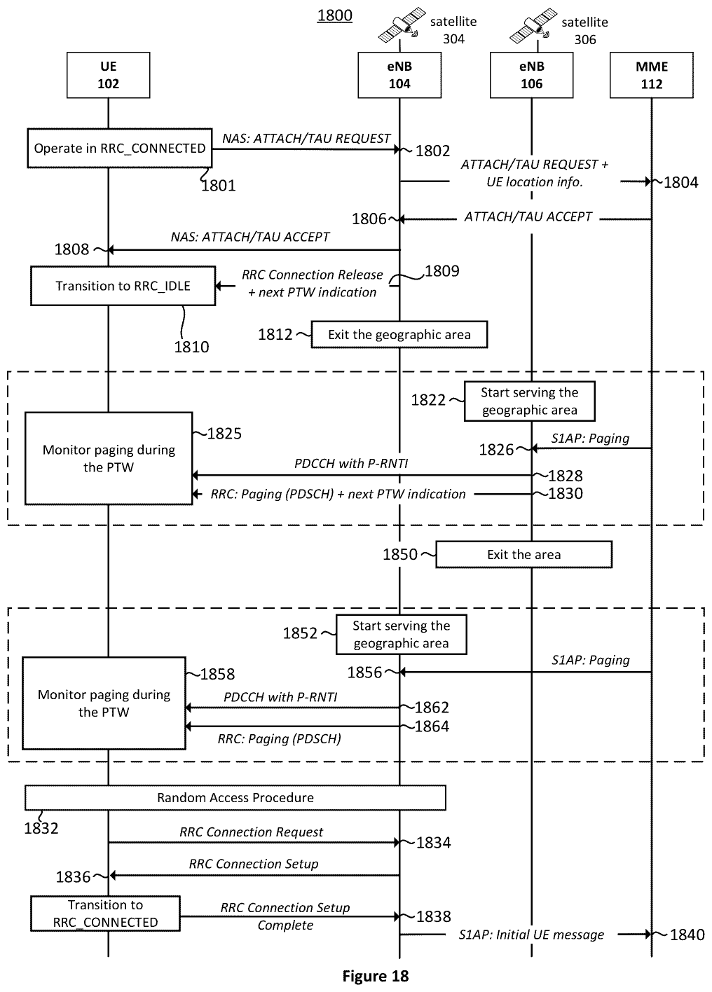

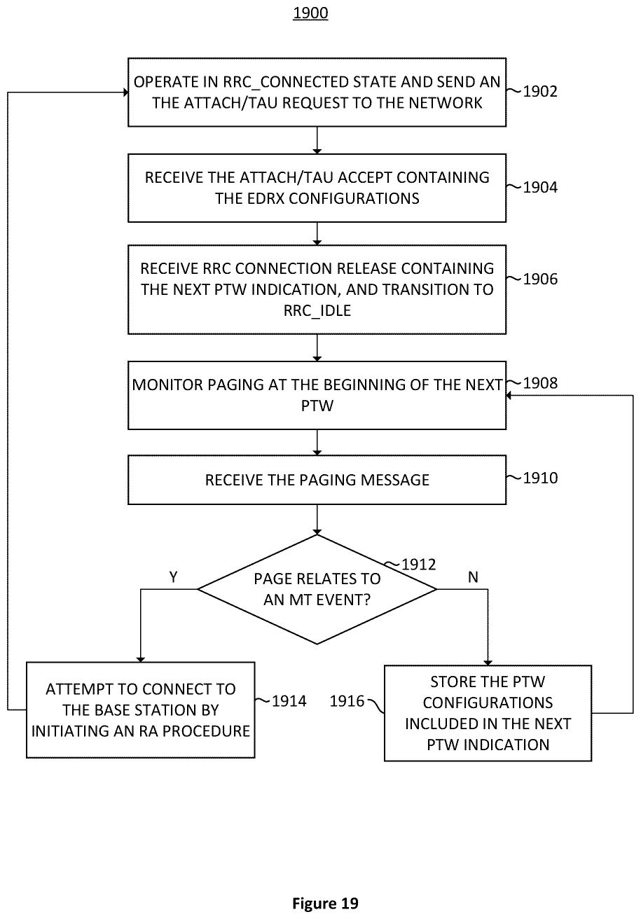

Next, FIG. 17 illustrates an approach according to which the UE and the network determine the PTW dynamically. These techniques are further discussed with reference to the messaging diagram of FIG. 18 and the flow diagram of FIG. 19.

In this scenario, the UE operates in the RRC_CONNECTED state during the period of coverage 1702 by the first satellite. The UE then receives an RRC Connection Release 1704 message from the base station and accordingly transitions into RRC_IDLE. The RRC Connection Release message 1704, or the NAS message encapsulated by the RRC Connection Release message, contains a “next PTW” indication specifying the start time and the duration of the first PTW (in this case, the PTW 1708). To align the first PTW 1708 with the period of coverage 1706 by the upcoming satellite, the network (e.g., the MME 112) may determine the location of the UE, so that the network can calculate with sufficient precision the start time and the duration of the first PTW 1708. In another implementation, the network determines and assigns to the UE an earlier start time and a longer duration for the first PTW 1708, to ensure that the first PTW 1708 will still substantially coincide with the period of the coverage 1706, shifted forward or backward in time due to the UE's potential range of movement.

In accordance with the ‘next PTW’ indication included in the RRC Connection Release message, the UE wakes up and monitors paging during the first PTW 1708. The UE can receive a paging message during the first PTW 1708, and the paging message can contain another “next PTW” indication for the UE. If the UE determines that the page is not for a pending MT event, the UE resumes the sleep mode and wakes up for the next PTW 1712 which the paging message configured using the “next PTW” indication. However, if the UE receives a paging message during the first PTW 1708, and the paging message specifies the identity of the UE but does not contain another “next PTW” indication, the UE can determine that the page pertains to a pending MT event. The UE in this case proceeds to set up an RRC connection with the base station.

FIG. 18 is messaging diagram of an example scenario 1800 in which the UE 102 and one or more network nodes dynamically determine the timing of the next PTW, as discussed above with reference to FIG. 17. Events 1801-1812 are generally similar to the events 1201-1212 of FIG. 12 and the events 1501-1512 of FIG. 15, except that here the BS 104 transmits 1809 a command to release the RRC connection (e.g., the RRC Connection Release command) including a “next PTW” indication.

In particular, the RRC Connection Release message, or the NAS message included in the RRC Connection Release message, contains a “next PTW” indication that specifies the start time and the duration of the first PTW, during which the UE 102 wakes up and monitors paging. The start time can be in the form of absolute time (e.g., the Coordinated Universal Time), or in the form of Hyper Frame Number (HFN) or System Frame Number (SFN).

In accordance with the “next PTW” indication received in the RRC Connection Release message, the UE 102 wakes up for the first PTW and monitors 1825 paging. The MME 112 also pages the UE in accordance with the next PTW indication. Events 1826, 1828, and 1830 are similar to the events 1226, 1228, and 1230 discussed with reference to FIG. 12, but if no MT event is related to the Paging message, the Paging message which the eNB 106 broadcasts 1830 includes another “next PTW” indication for the UE, to specify the start time and the duration of the second PTW. The satellite 306 then exits the area of coverage.

In accordance with the “next PTW” indication received in the Paging message during the first PTW, the UE 102 wakes up at the second PTW and monitors paging 1858. At this time, the satellite 304 starts serving 1852 the geographic area. The MME 112 can again send 1856 a Paging message to the UE 102 via the BS 104 during the second PTW. After receiving the Paging message from the MME 112, the BS 104 notifies 1862 the UE 102 of the scheduling of the paging message through the PDCCH addressed to the UE using a P-RNTI. The BS 104 then broadcasts 1864 the Paging message at the scheduled time and frequency resource through the PDSCH, and the Paging message related to an MT event can contain the identity (i.e., S-TMSI or IMSI) of the UE 102. Events 1832-1840 are similar to the events 1232-1240 discussed above.

FIG. 19 is a flow diagram of example method 1900 for determining the starting time of a dynamic PTW, which can be implemented in the UE 102 or another suitable UE. The UE may not be capable of estimating/predicting the pattern of discontinuous coverage.

The method 1900 begins at block 1902, when the UE operates 1801 in RRC_CONNECTED and sends 1802 the ATTACH REQUEST or TAU REQUEST message including the preferred eDRX configurations to the network (e.g., the MME). At block 1904, the UE receives 1808 the ATTACH ACCEPT or the TAU ACCEPT message containing the confirmed eDRX configurations. At block 1906, the UE receives 1809 an RRC Connection Release message from the base station and transitions 1810 to the RRC_IDLE state. The RRC Connection Release message contains the “next PTW” indication specifying when, and for how long, the UE should wake up and monitor paging.

The UE wakes up in accordance with the “next PTW” indication received in the RRC Connection Release message and monitors 1825 paging at the specified time (block 1908). At block 1910, before the PTW completes, the UE receives 1828, 1830 a paging message from the base station.

At block 1912, the UE determines whether the page relates to a pending MT event. If the paging message contains a “next PTW” indication and references the identity of the UE, the UE determines that the network is not paging the UE at this time, and the flow proceeds to block 1916, where the UE stores the PTW configuration included in the “next PTW” indication. The UE then remains in the RRC_IDLE state, and the flow returns to block 1908. On the other hand, if the paging message contains the identity of the UE but does not contain a “next PTW” indication, the UE determines that the network is paging the UE in connection with an MT event. The flow proceeds to block 1914 in this case, and the UE attempts to connect to the base station by initiating 1832 an RA procedure. The UE transitions to the RRC_CONNECTED state, and the flow returns to block 1902.

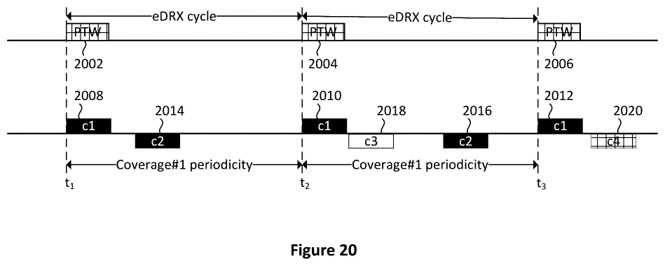

FIG. 20 illustrates yet another technique for addressing the problem discussed in connection with FIG. 7. According to this approach, the UE and the network align the eDRX cycle with the periodicity of a certain satellite returning to the geographic area. In this manner, the UE and the network can control the paging delay within a reasonable/acceptable range. In the scenario of FIG. 20, the UE wakes up and monitors the paging during the first PTW 2002, where the start of the PTW 2002 aligns with the period of coverage 2008 by the first satellite c1. If the network does not page the UE during the PTW 2002, the next time the UE wakes up and monitors paging is at the beginning of the second PTW 2004, which is also the time when the UE enters again the area of coverage provided by the first satellite. Thus, the interval between two consecutive PTWs (i.e., the length of the eDRX cycle) is configured to be equal to the interval between two consecutive periods of coverage by the first satellite. This approach does not depend on the coverages provided by other satellites (e.g., c2 2014, c2 2016, c3 2018, and c4 2020). The UE does not need to wake up at these non-c1 periods of coverage, in this implementation.

Because the 3GPP TS 24.008 specification (v17.5.0) only allows the network to use 4 bits to configure the eDRX cycle length (i.e., only 16 values are possible), and the time required for a satellite to travel to the same position can be any arbitrary value, the network may need more bits to signal/configure the eDRX cycle length with an arbitrary value, ranging from few seconds to tens of thousands of seconds. Thus, the ‘Extended DRX parameters IE’ in the ATTACH REQUEST, ATTACH ACCEPT, TAU REQUEST, and TAU ACCEPT messages needs to be extended, so that the network can use more bits (for example, 17 bits) to configure the eDRX cycle length.

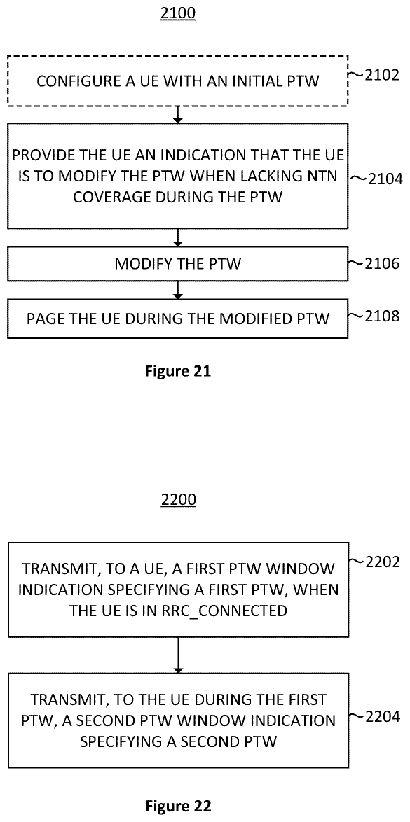

FIG. 21 is a flow diagram of an example method 2100 for paging a UE via an NTN using modifications of an initial PTW configuration. At optional block 2102, a network device configures the UE with a PTW. In some implementations, the configuration also explicitly indicates the duration of a sleep period which the UE enters after the PTW to operate in a lower-power sleep mode. In other implementations, the UE stores a default configuration of the PTW and/or the sleep period.

At block 2104, the network device provides an indication that the UE is to modify the PTW if the UE lacks NTN coverage during the PTW. The indication can be for example a PTW shift indication or a PTW extension indication. Depending on the implementation, the indication can be a binary flag or a data structure with additional information, such as whether the shift is forward or backward in time. At block 2106, the network device modifies the PTW to match the UE operation. Finally, at block 2108, the network device pages the UE during the modified PTW.

FIG. 22 is a flow diagram of an example method 2200 for paging a UE via an NTN using dynamic “next PTW” indications. At block 2202, the network device transmits to the UE operating in a connected state (e.g., RRC_CONNECTED) a first PTW indication to specify a first PTW. At block 2204, during the first PTW, the network device transmits to the UE a second PTW indication to specify a second PTW. During the first PTW, the UE operates in a non-connected state (e.g., RRC_IDLE).

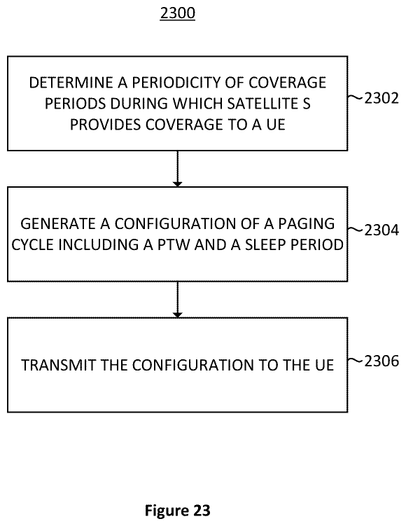

FIG. 23 is a flow diagram of an example method 2300 for paging a UE via an NTN using alignment of a PTW with periodicity of satellite coverage. The method 2300 begins at block 2302, where the network device determines a periodicity of coverage periods during which a certain satellite S provides coverage to the UE. As discussed above, the coverage periods are separated by intervals of time during which this satellite does not provide coverage to the UE. At block 2304, the network device generates a configuration of a paging cycle with a PTW and, in some cases, a sleep period (which, depending on the implementation, can be an explicit or implicit indication). The network selects the duration cycle so that the PTW aligns, partially or completely, with a period of coverage by the satellite S. At block 2306, the network device transmits the configuration to the UE.

The following description may be applied to the description above.

Generally speaking, description for one of the above figures can apply to another of the above figures. Any event or block described above can be optional. For example, an event or block with dashed lines can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. The “eNB” can be replaced by “base station”, “gNB”, “6G base station”, “evolved gNB” or 6G gNB. The “ATTACH REQUEST” message and “ATTACH ACCEPT” message can be replaced by “REGISTRATION REQUEST” message and “REGISTRATION ACCEPT” message, respectively. “MME” can be replaced by AMF or evolved AMF or 6G AMF. “RRC Connection Release message” can be replaced by “RRC Release message”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

In preparation for 3GPP TSG-RAN WG2 Meeting#118-e held in May 9-20, the inventor prepared for discussion and adoption in standards, methods and devices improving assistance information for predicting the discontinuous coverage. Given the UE needs to predict the coverage for two types of satellites (the quasi-Earth-fixed cell and the Earth-moving cell), embodiments described hereinafter enable a clear mapping between the contents of the assistance information and the types of satellite, provide missing pieces of information and prevent the network from broadcasting redundant information.

In some embodiments, in order to assist the UE in predicting the coverage of the quasi-Earth-fixed cell, the network provides the satellite footprint reference location and the coverage radius of the quasi-Earth-fixed cell. Each UE can then determine whether it will be within the coverage of the incoming satellite by doing some simple calculation based on the received information and its GNSS coordinate.

As not every satellite projects its beam(s) perpendicularly onto the Earth, in some embodiments, the eNB provides additional information such as the antenna panel tilt, to facilitate UEs to determine the central location of the Earth-moving cell. Thus, in order to assist UEs to predict the coverage of an earth-moving cell, in addition to the mean/average ephemeris information, the network provides the antenna panel tilt, as well as the coverage radius, of both the serving and incoming cells.

Since the information set for predicting the coverage of an Earth-moving cell is different from the information set for predicting the coverage of a quasi-Earth-fixed cell, in some embodiments the SatelliteInfo-r17 information element, IE, contains two IEs under the CHOICE structure. One IE contains the assistance information for predicting the Earth-moving cell and the other contains the assistance information for predicting the quasi-Earth-fixed cell. In this way, the possibility of having redundant information in SIB32 is eliminated. In addition, since different UEs may have different preference on staying with a certain type of satellite (e.g., Earth-moving vs. quasi-Earth-fixed), and such preference can be influenced by the way UE is implemented, by the PLMN the UE selects, and by the type of the cell which the UE is currently camping on, having two separate IEs representing two cell types in SatelliteInfo-r17 makes UE implementation easier for picking/filtering the information it needs to predict the satellite coverage.

One implementation of these features is reproduced below:

### SystemInformationBlockType32 Information Element

-- ASN1START
SystemInformationBlockType32-r17 ::= SEQUENCE {

| | | |
|---|---|---|
| satelliteInfoList-r17 | SatelliteInfoList-r17 | OPTIONAL, -- Need OR |
| lateNonCriticalExtension | OCTET STRING | OPTIONAL, |

...
}
SatelliteInfoList-r17 ::= SEQUENCE (SIZE (1..maxSat-r17)) OF SatelliteInfo-r17
SatelliteInfo-r17 ::= CHOICE {

| | |
|---|---|
| quasiEarthFixedInfo-r17 | QuasiEarthFixedInfo-r17, |
| earthMovingInfo-r17 | EarthMovingInfo-r17, |

...
}
QuasiEarthFixedInfo-r17 ::= SEQUENCE {

| t-Service-r17 | TimeUTC-r17, | |
|---|---|---|
| referenceLocation-r17 | ReferenceLocation-r17 | OPTIONAL, -- Need R |
| coverageRadius-r17 | CoverageRadius-r17 | OPTIONAL, -- Need R |

...
}
EarthMovingInfo-r17 ::= SEQUENCE {

| ephemerisOrbitalParameters-r17 | EphemerisOrbitalParameters-r17, | |
|---|---|---|
| antennaPanelTilt-r17 | AntennaPanelTilt-r17 | OPTIONAL, -- Need R |
| coverageRadius-r17 | CoverageRadius-r17 | OPTIONAL, -- Need R |

...
}
ReferenceLocation-r17 ::= ENUMERATED { ffs }
CoverageRadius-r17 ::= ENUMERATED { ffs }
AntennaPanelTilt-r17 ::= ENUMERATED { ffs }
-- ASN1STOP

SystemInformationBlockType32 field descriptions

ephemerisOrbitalParameters
Mean values of the satellite orbital parameters.
t-Service
Time information on when the incoming satellite is going is to start serving the area for Quasi-Earth Fixed satellites.
quasiEarthFixedInfo
Assistance information used to predict the coverage of a cell provided via NTN quasi-Earth fixed system.
earthmovingInfo
Assistance information used to predict the coverage of a cell provided via NTN Earth moving system.
referenceLocation
Reference location of a cell provided via NTN quasi-Earth fixed system. FFS for exact field description.
coverageRadius
Coverage radius of a cell provided via NTN quasi-Earth fixed or NTN Earth moving system. FFS for exact field
description.
antennaPanelTilt
Antenna panel tilt (in degree) of the NTN satellite providing the Earth moving cell. FFS for exact field description.

According to a first example, a method performed by a UE, for monitoring paging from an NTN includes: receiving, from the NTN, a configuration of a paging time window (PTW) during which the UE operating in non-connected state monitors paging messages and after the PTW, enters a sleep period during which the UE operates in a low-power sleep mode. The method further includes: determining that the UE lacks NTN coverage during the PTW, and modifying the PTW to generate a modified PTW in response to the determining.

The modifying may include adjusting a start time for the PTW so that the UE has network coverage during the modified PTW. The method may further include receiving, from the NTN, a PTW shift indication indicating that the UE is allowed to modify the PTW. The PTW shift indication may indicate whether the PTW is to be shifted forward in time or backward in time relative to a time in the received configuration.

The method may further include determining one or more coverage time intervals within the sleep period during which the UE has network coverage, and the adjusting of the start time may include shifting the PTW to overlap at least one of the one or more coverage time intervals.

In one embodiment, the determining of the one or more coverage time intervals includes: receiving, from the NTN, assistance information related to attributes of cells projected onto a surface of the Earth by a Non-Geosynchronous Orbit (NGSO) satellite operating in the NTN and providing a quasi-Earth-fixed service link. In another embodiment, the determining the one or more coverage time intervals includes: receiving, from the NTN, assistance information related to attributes of an NGSO satellite operating in the NTN and providing an Earth-Moving service link.

The modifying may include adjusting an end time for the PTW without adjusting a start time for the PTW, to configure the modified PTW to extend a duration of the PTW with an extension period, so that the UE has network coverage during the extension period. In this case, the method may further include receiving, from the NTN, a PTW extension indication indicating that the UE is allowed to extend the PTW. The method may also include terminating the PTW in response to receiving a paging message during a paging occasion within the extension period or in response to expiration of a timer activated upon adjusting the end time for the PTW.

The method may also include transmitting, to the NTN, a preferred eDRX configuration. The receiving of the configuration of the PTW may include receiving an initial eDRX configuration.

According to a second example, a method performed by a UE for monitoring paging from an NTN includes: (i) receiving, from the NTN and when the UE is in a connected state, a first PTW indication specifying a first PTW during which the UE operating in non-connected state monitors paging messages, and (ii) receiving, by one or more processors during the PTW, a second PTW indication specifying a second PTW.

The receiving of the first PTW indication may include receiving a command to release a radio connection. The receiving of the second PTW indication may include receiving a paging message. The method may further include determining, based on a presence of the second PTW indication, that no mobile-terminated (MT) event is pending delivery to the UE, and that the UE is to continue operating in a non-connected state, and absence of a PTW indication in the paging message indicates that the UE is to transition to a connected state. The non-connected state may be RRC_IDLE or RRC_INACTIVE. The method may also include receiving, from the NTN, an initial eDRX configuration.

According to an embodiment, a UE with one or more processors is configured to implement the above-described first and second example methods with their variations.

According to a third example, there is a method for paging, via an NTN, a user equipment (UE) configured with a PTW during which the UE operating in non-connected state monitors paging messages, and after the PTW, enters a sleep period during which the UE operates in a lower-power sleep mode. This method implemented in a network device includes: (i) providing, to the UE, an indication that the UE is to modify the PTW if the UE lacks NTN coverage during the PTW, (ii) modifying the PTW to generate a modified PTW, and (iii) paging during to the modified PTW. The modifying may include adjusting a start time for the PTW so that the UE has network coverage during the modified PTW.

In one embodiment, the providing of the indication includes providing a PTW shift indication indicating that the UE is allowed to modify the PTW. In another embodiment, the providing of the indication includes providing a PTW shift indication, to indicate whether the PTW is to be shifted forward in time or backward in time relative to a time in the initial configuration.

The method may further include determining one or more coverage time intervals within the sleep period when the UE has network coverage, and then the adjusting of the start time includes shifting the PTW to overlap at least one of the one or more coverage time intervals.

The method may further include transmitting, to the UE, assistance information related to attributes of cells projected onto a surface of the Earth via a Non-Geosynchronous Orbit (NGSO) satellite operating in the NTN and providing a quasi-Earth-fixed service link. The method may alternatively include transmitting, to the UE, assistance information related to attributes an NGSO satellite operating in the NTN and providing an Earth-Moving service link.

The modifying may include adjusting an end time for the PTW without adjusting a start time for the PTW, to configure the modified PTW to extend a duration of the PTW with an extension period, so that the UE has network coverage during the extension period. The method may then further include transmitting, to the UE, a PTW extension indication indicating that the UE is allowed to extend the PTW.

The method may further include receiving, from the UE, a preferred eDRX configuration. Alternatively or additionally, the method may include transmitting, to the UE, an initial eDRX configuration including the PTW.

According to a fourth example, a method performed by a network device for paging a UE via an NTN includes (i) transmitting, to the UE when the UE is in a connected state, a first PTW indication specifying a first PTW during which the UE operating in non-connected state monitors paging messages, and (ii) transmitting, by one or more processors to the UE during the PTW, a second PTW indication specifying a second PTW.

The transmitting of the first PTW indication may include transmitting a command to release a radio connection. The transmitting of the second PTW indication may include transmitting a paging message. The transmitting of the second PTW indication with the paging message may be in response to determining that there is no mobile-terminated (MT) event pending delivery to the UE, and that the UE is to continue operating in a non-connected state.

According to a fifth example, a method performed by a network device for paging, via an NTN, a UE includes determining a periodicity of coverage periods during which a certain satellite provides coverage to the UE, the coverage periods separated by intervals of time during which the satellite does not provide coverage to the UE. The method further includes generating, by the one or more processors, a configuration of a paging cycle including (i) a PTW during which the UE operating in non-connected state monitors paging messages, and (ii) a sleep period during which the UE operates in a sleep mode, including selection a duration of the paging cycle based on the periodicity of the coverage periods. The method also includes transmitting, to the UE, the configuration.

The method may also include configuring the duration of the paging cycle to be equal to the periodicity of the coverage periods. The configuration may be an eDRX configuration.

According to an embodiment, a network device with one or more processors is configured to implement any of the above-described third, fourth and fifth example methods with their variations.

1-16. (canceled)

17. A method performed by a network device for paging a user equipment, UE, the method comprising:
transmitting, to the UE, non-terrestrial network, NTN, cell-related assistance information including attributes defining one or more NTN cells including a serving cell of the UE projected onto a certain geographical area, and a reference location and a radius of the serving cell.

18. The method of claim 17, further comprising:
transmitting, to the UE, a configuration configuring the UE to monitor paging messages during a paging time window, PTW, while the UE operates in a non-connected state.

19. The method of claim 17, wherein the NTN cell-related assistance information indicates when the serving cell stops serving the certain geographical area.

20. The method of claim 17, wherein the NTN cell-related assistance information includes attributes of a neighbor NTN cell projected onto the certain geographical area, the neighbor NTN cell being served via a non-geosynchronous, NGSO, satellite that provides a quasi-Earth-fixed service link.

21. The method of claim 20, wherein the attributes of the neighbor NTN cell include a neighbor-cell central coordinate and a neighbor cell radius.

22. The method of claim 20, wherein the attributes of the neighbor NTN cell include a start time when the neighbor cell starts serving the certain geographical area and a stop time when the neighbor cell no longer serves the certain geographical area.

23. The method of claim 17, wherein the network device is a non-geosynchronous, NGSO, satellite that provides a quasi-Earth-fixed service link.

24. The method of claim 17, wherein the transmitting of the NTN cell-related assistance information includes broadcasting a system information block, SIB.

25. The method of claim 24, wherein the SIB is an SIB type 32, SIB32.

26. The method of claim 17, further comprising:
paging the UE during a pre-configured paging time window, PTW.

27. A method performed by a network device for paging a user equipment, UE, the method comprising:
transmitting, to the UE, satellite-related assistance information including a radius of an Earth-moving cell and an angle of an antenna panel tilt, the network device being a non-geosynchronous, NGSO, satellite that provides an Earth-moving service link.

28. The method of claim 27, wherein the satellite-related assistance information includes satellite constellation information of the NGSO satellite and another satellite.

29. The method of claim 27, wherein the satellite-related assistance information further includes a minim angle and a maxim angle of the antenna panel tilt.

30. The method of claim 27, wherein the transmitting of the satellite-related assistance information includes broadcasting a system information block, SIB.

31. The method of claim 30, wherein the SIB includes a first data structure for a quasi-Earth-fixed information and a second data structure for an Earth-moving information.

32. The method of claim 31, wherein the SIB is an SIB type 32, SIB32.

33. The method of claim 27, wherein the Earth-moving cell has a non-circular shape.

34. The method of claim 27, further comprising:
paging the UE during a pre-configured paging time window, PTW.

35. A network entity communicating with a user equipment, UE, via a non-terrestrial network, NTN, the network entity comprising:
a processor and a transmitter configured to transmit, to the UE,
NTN cell-related assistance information including attributes defining one or more NTN cells including a serving cell of the UE projected onto a certain geographical area, and a reference location and a radius of the serving cell, and/or
satellite-related assistance information including a radius of an Earth-moving cell and an angle of an antenna panel tilt, the network device being a non-geosynchronous, NGSO, satellite that provides an Earth-moving service link.

36. The network entity of claim 35, wherein the processor and the transmitter are configured to broadcast the NTN cell-related assistance information and/or the satellite-related assistance information as a system information block type 32, SIB 32.
